(19) United States
(12) Patent Application Publication
(10) Pub. No.: US 2011/0143023 A1
(43) Pub. Date: Jun. 16, 2011

(54) GAS SENSOR USING POROUS NANO-FIBER CONTAINING METAL OXIDE AND MANUFATURING METHOD THEREOF

(75) Inventors: Young Seak Lee, Daejeon (KR); Seok Chang Kang, Daejeon (KR); Sung Kyu Lee, Daejeon (KR); Ji Sun Im, Daejeon (KR)

(73) Assignee: Chungnam National University Industry Collaboration Foundation, Daejeon (KR)

(21) Appl. No.: 12/969,069

(22) Filed: Dec. 15, 2010

(30) Foreign Application Priority Data
Dec. 16, 2009 (KR) 10-2009-0125174

(51) Int. Cl. B05D 5/12; B82Y 40/00; B82Y 15/00

(52) U.S. Cl. 427/126.3; 977/888; 977/957

(57) ABSTRACT

Disclosed is a method of manufacturing a gas sensor by using a nano-fiber including metal oxide. The method of manufacturing the gas sensor includes the steps of (1) mixing a polymer precursor with a solvent, (2) dispersing metal oxide into the mixture obtained through step (1), (3) preparing a nano-fiber by performing electro-spinning with respect to the mixture obtained through step (2), (4) oxidizing the nano-fiber obtained through step (3), (5) carbonizing the nano-fiber that has been oxidized through step (4), (6) activating the nano-fiber that has been carbonized through step (5), and (7) manufacturing the gas sensor by depositing the nano-fiber, which has been activated through step (6), between electrodes of a silicon wafer. The gas sensor is manufactured with superior sensitivity at a normal temperature and reliability.

### BACKGROUND OF THE INVENTION

1. Field of the Invention

The present invention relates to a gas sensor. More particularly, the present invention relates to a method of manufacturing a gas sensor, which can represent reliability with remarkably high sensitivity at a normal temperature, by using a porous nano-fiber including metal oxide, and the gas sensor manufactured through the method.

2. Description of the Prior Art

In general, a gas sensor measures the quantity of noxious gas based on a characteristic in which the electrical conductivity varies according to the adsorption of gas molecules. Materials mainly used in the gas sensor include a metal oxide semiconductor such as SnO₂, a solid electrolyte material, various organic materials, and the complex of carbon black and an organic material. The gas sensor manufactured by using the above materials has many problems such as restricted use. In other words, a gas sensor manufactured by using the metal oxide semiconductor or the solid electrolyte material has to be heated at the temperature of about 200° C. to 600° C., or more in order to perform the normal operation. A gas sensor manufactured by using the organic material represents extremely low electrical conductivity, and a gas sensor manufactured by using the complex of the carbon black and the organic material represents significantly low sensitivity. In addition, the conventional gas sensors manufactured by the above materials requires long time for sensing, represents remarkably low recovery speed, and requires a high price, so that the conventional gas sensors are unsuitable for general purposes.

### SUMMARY OF THE INVENTION

The present invention has been made to solve the above problem occurring in the prior art, and an object of the present invention is to provide a gas sensor and a method of manufacturing the same, capable of representing remarkably high sensitivity at a normal temperature by preparing a nano-fiber including metal oxide through electro-spinning, and depositing the nano-fiber between silicon wafer electrodes after oxidizing, carbonizing, and activating the nano-fiber.

In order to accomplish the object, there is provided a method of manufacturing a gas sensor by using a nano-fiber including metal oxide. The method of manufacturing the gas sensor includes the steps of (1) mixing a polymer precursor with a solvent, (2) dispersing metal oxide into the mixture obtained through step (1), (3) preparing a nano-fiber by performing electro-spinning with respect to the mixture obtained through step (2), (4) oxidizing the nano-fiber obtained through step (3), (5) carbonizing the nano-fiber that has been oxidized through step (4), (6) activating the nano-fiber that has been carbonized through step (5), and (7) manufacturing the gas sensor by depositing the nano-fiber, which has been activated through step (6), between electrodes of a silicon wafer.

Preferably, the method further includes performing heat treatment with respect to the gas sensor, which has been obtained through step (7), after step (7) has been performed. Preferably, the heat treatment is performed at a temperature of 30° C. to 80° C. for 0.1 to one hour.

Preferably, the mixture, which has been obtained through step (2), has viscosity in the range of 100 cP to 500 cP.

Preferably, in step (2), 2 to 10 parts by weight of the metal oxide is dispersed into the mixture, which has been obtained through step (1), based on 100 parts by weight of the mixture. The activation degree of the nano-fiber is increased by adding the metal oxide serving as a catalyst, thereby manufacturing the gas sensor having superior sensitivity and rapid response.

Preferably, in step (4), the nano-fiber is oxidized while raising a temperature at a rate of 1° C./min to 5° C./min, and oxidized at a temperature of 200° C. to 300° C. for two hours to five hours in a final stage.

Preferably, in step (5), the nano-fiber is carbonized while raising a temperature at a rate of 5° C./min to 10° C./min, and carbonized at the temperature of 800° C. to 1200° C. for a half an hour to two hours in a final stage.

Preferably, the activation in step (6) of the nano-fiber is achieved by applying a potassium hydroxide solution, and the potassium hydroxide solution has density in a range of 5 M to 10 M.

Preferably, in step (7), the gas sensor is manufactured by dispersing the nano-fiber, which has been obtained through step (6), into a dispersion solution and depositing the nano-fiber between electrodes of a silicon wafer, and a ratio of the nano-fiber dispersed into the dispersion solution is in a range of 0.1 to 3 parts by weight based on 100 parts by weight of the dispersion solution.

In addition, the present invention provides a gas sensor manufactured through the method.

As described above, the gas sensor capable of representing remarkably high sensitivity at a normal temperature can be manufactured by preparing a nano-fiber including metal oxide through electro-spinning, and depositing the nano-fiber between silicon wafer electrodes after oxidizing, carbonizing, and activating the nano-fiber.

### BRIEF DESCRIPTION OF THE DRAWINGS

FIG. 1 is a schematic view showing a gas sensor manufactured according to an embodiment of the present invention;

FIG. 2 is a schematic view showing electro-spinning equipment used to prepare a nano-fiber;

FIG. 3 is a view showing nitrogen adsorption isotherms used to determine the porosity of nano-fibers prepared according to embodiment 1 and comparative example 1 of the present invention;

FIG. 4 is an SEM image taken to examine the surface characteristic of the gas sensor manufactured according to the embodiment of the present invention;

FIG. 5 is a schematic view showing a device to measure a gas sensing characteristic; and

FIG. 6 is a graph showing a sensing characteristic for NO gas of gas sensors prepared according embodiment 2 and comparative example 2 of the present invention.

### DETAILED DESCRIPTION OF THE PREFERRED EMBODIMENTS

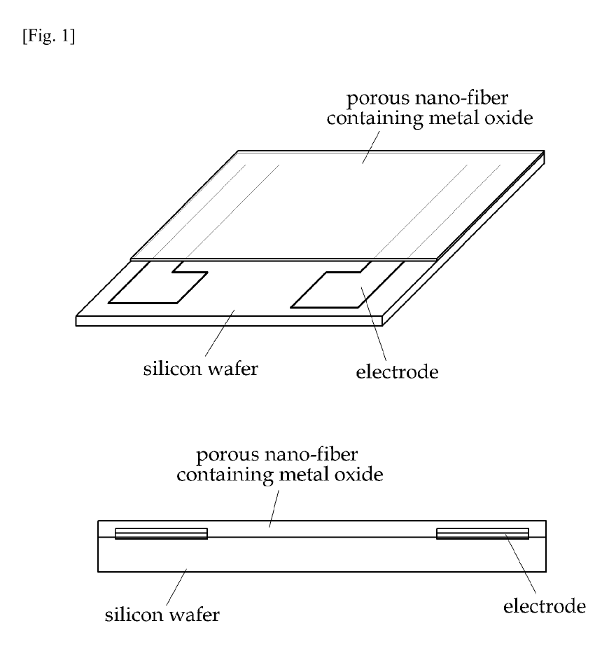

The present invention provides a gas sensor manufactured by using a nano-fiber including metal oxide and a method of manufacturing the same. FIG. 1 is a schematic view showing a gas sensor manufactured according to an embodiment of the present invention. As shown in FIG. 1, in the gas sensor according to the present invention, porous nano-fibers including metal oxide are uniformly distributed between electrodes of a silicon wafer.

Hereinafter, the present invention will be described in detail.

The present invention provides the method of manufacturing the gas sensor by using the porous nano-fibers including metal oxide. The method of manufacturing the gas sensor includes the steps of (1) mixing a polymer precursor with a solvent, (2) dispersing metal oxide into the mixture obtained through the step (1), (3) preparing a nano-fiber by performing electro-spinning with respect to the mixture obtained through the step (2), (4) oxidizing the nano-fiber obtained through the step (3), (5) carbonizing the nano-fiber oxidized through the step (4), (6) activating the nano-fiber carbonized through the step (5), and (7) manufacturing the gas sensor by depositing the nano-fiber, which has been activated through the step (6), between electrodes of the silicon wafer.

The polymer precursor used in the step (1) may include various materials that can be changed into carbon. In detail, the polymer precursor may be selected from the group consisting of petroleum pitch, coal pitch, polyimide, polybenzimidazol, polyacrylonitrile, polyaramid, polyaniline, mesophase pitch, furfuryl alcohol, phenole, cellulose, sucrose, poly (vinyl chloride), and the mixture thereof.

The solvent used in the step (1) may include various solvents capable of dissolving the polymer precursor. For example, the solvent may be selected from the group consisting of dimethylformamide, chloroform, N-methylpyrrolidonetetrahydrofuran, sulfuric acid, nitric acid, acetic acid, hydrochloric acid, ammonia, distilled water, and the mixture thereof.

The metal oxide used in the step (2) is not limited to a specific type, but generally-known metal oxide may be used.

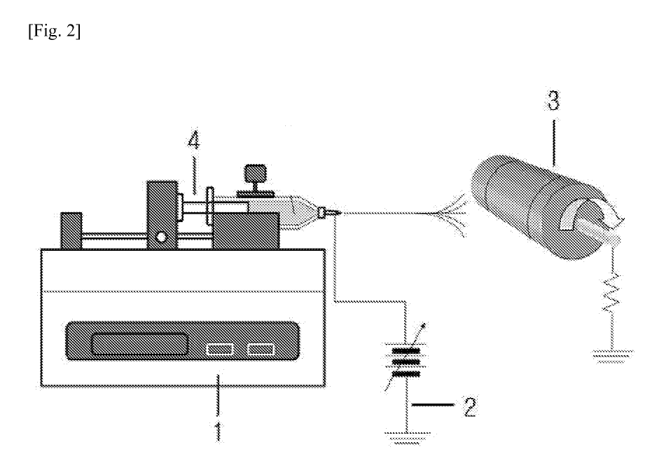

The viscosity of the mixture obtained in the step (2) is preferably in the range of about 100 cP to about 500 cP. The mixture, which has been obtained in the step (2), is subject to the electro-spinning process in the next step by using electro-spinning equipment shown in the schematic view of FIG. 2. The electro-spinning equipment is typical electro-spinning equipment. Hereinafter, the operation of the electro-spinning equipment will be briefly described. As shown in FIG. 2, the electro-spinning equipment includes a metering pump 1, a voltage generator 2, a concentrator 3, and a radiator 4. First, a solution is injected into the radiator 4 through the metering pump 1, and the solution radiated through the radiator 4 is concentrated by the concentrator that is rotating. The voltage generator 2 applies a desired voltage. In other words, the mixture obtained in the step (2) is radiated through the radiator 4. However, if the viscosity of the mixture exceeds 500 cP, the nozzle of the radiator 4 is clogged due to the cohesive force between polymer molecules, so that the solution is not smoothly radiated. In addition, if the viscosity of the mixture is less than 100 cP, the polymers do not form a predetermined shape due to the significantly low viscosity.

When dispersing metal oxide into the mixture, which has been obtained through the step (1), in the step (2), 2 to 10 parts by weight of the metal oxide is preferably mixed with the mixture based on 100 parts by weight of the mixture. If less than 2 parts by weight of the metal oxide is mixed, the activation degree of the nano-fiber is not changed when comparing with a case in which the metal oxide is not mixed. Accordingly, the less than 2 parts by weight of the metal oxide is not proper. If more than 10 parts by weight of the metal oxide is mixed, the metal oxide is difficult to be dispersed into the mixture obtained in the step (1). Accordingly, more than 10 parts by weight of the metal oxide is not proper.

In order to prepare the nano-fiber by performing the electro-spinning with respect to the mixture, which has been obtained through the step (2), in the step (3), a typical electro-spinning process is performed by using the electro-spinning equipment shown in FIG. 2.

When oxidizing the nano-fiber in step (4), preferably, the nano-fiber is oxidized while raising a temperature at a rate of 1° C./min to 5° C./min, and oxidized at the temperature of 200° C. to 300° C. for two hours to five hours in the final stage.

If the nano-fiber is oxidized while raising a temperature at a rate of lower than 1° C./min, cyclization reaction caused by the reaction of oxygen and carbon may not smoothly occur due to the lower reaction rate, and a fiber yield rate may be degraded. If the nano-fiber is oxidized while raising a temperature at a rate of more than 5° C./min, the nano-fiber is unstably formed due to the fast reaction rate, so that the nano-fiber may be melted or subject to glass transition in the carbonizing step that is the next step. As a result, the nano-fiber cannot maintain a fiber form. If the oxidization temperature is less than 200° C., the oxidation reaction may unstably occur, so that the nano-fiber may be melted or subject to glass transition in the carbonizing step that is the next step, and the nano-fiber cannot maintain a fiber form. In addition, condensation reaction between carbon atoms is not smoothly achieved. In addition, if the oxidization temperature exceeds 300° C., the reaction may be rapidly induced due to the high temperature, so that cyclization a carbon-oxygen bond reaction may not smoothly occur due to in an excessive oxygen state. If an oxidizing process is preformed for less than two hours, there occurs a phenomenon the same as that of a case in which the final oxidization temperature is less than 200° C. In addition, if the oxidization time exceeds five hours, there is no difference from when the oxidation is performed for five hours, and undesirable reaction may occur.

When carbonizing the nano-fiber in step (5), the nano-fiber is carbonized while raising a temperature at a rate of 5° C./min to 10° C./min, and carbonized at the temperature of 800° C. to 1200° C. for a half an hour to two hours in the final stage. If the nano-fiber is carbonized at a rate of lower than 5° C./min and if the nano-fiber is carbonized at a temperature exceeding 1200° C., reaction time is prolonged and a great amount of energy is consumed. If the temperature is raised at a rate of more than 10° C./min, volatilization significantly occurs, so that the yield rate of the nano-fiber may be lowered. If the nano-fiber is carbonized at a temperature of lower than 800° C., the carbonization may not occur completely. If the nano-fiber is carbonized for less than a half an hour, the nano-fiber may be insufficiently carbonized. If the nano-fiber is carbonized for more than five hours, there is no difference from when the nano-fiber is carbonized for five hours, and insufficient reaction may occur.

In the step (6), the activation of the nano-fiber is achieved by applying a potassium hydroxide solution, and the density of the potassium hydroxide solution is preferably in the range of 5 M to 10 M. If the density of the potassium hydroxide solution is less than 5 M, the activation may not occur sufficiently. If the density of the potassium hydroxide solution exceeds 10M, there is no difference from when the density of the potassium hydroxide solution is identical to 10M, so that the increase of the density of the potassium hydroxide to more than 10M has no special benefit in practice.

When manufacturing the gas sensor in step (7), the nano-fiber, which has been activated through the step (6), is dispersed into a dispersion solution, and deposited between electrodes of a silicon wafer. Various types of dispersion solutions may be used. For example, the dispersion solution may be selected from the group consisting of ethanol, methanol, acetone, dimethylformamide, and the mixture thereof. The ratio of the nano-fiber dispersed into the dispersion solution is preferably in the range of about 0.1 to 3 parts by weight based on 100 parts by weight of the dispersion solution. If less than 0.1 parts by weight of the nano-fiber is dispersed, the nano-fiber may be not uniformly distributed between the electrodes of the silicon wafer. If more than 3 parts by weight of the nano-fiber is dispersed, the nano-fiber is difficult to be dispersed in the dispersion solution. Hereinafter, the present step of manufacturing the gas sensor will be further described. After finely grinding the nano-fiber obtained through the step (6), the nano-fiber is uniformly dispersed in a dispersion solution at a desired ratio. Next, the solution having the dispersed nano-fiber is deposited on the silicon wafer in which a para film is attached to a wire connection part. The deposition may be performed through a vapor deposition scheme, a spin coating scheme, and a spray deposition scheme.

In addition, the present invention may further include a step of performing heat treatment with respect to the gas sensor, which has been obtained through the step (7), after the step (7) has been performed. The heat treatment is preferably performed at a temperature of about 30° C. to 80° C. for about 0.1 to one hour. If the temperature of the heat treatment is less than 30° C., the dispersion solution may be not easily evaporated. If the temperature of the heat treatment exceeds 80° C., a para film used to protect a connection part of a wire may be melted. If the time for the heat treatment is less than 0.1 hour, the dispersion solution may be not easily evaporated. If the time for the heat treatment exceeds one hour, effects are represented similarly to those of a case in which the time for the heat treatment is 1 hour.

In addition, the present invention provides a gas sensor manufactured through the method.

Hereinafter, the present invention will be described in more detail through embodiments.

### Embodiment 1

### Prepare of Porous Nano-Fiber Including Metal Oxide (Zinc Oxide)

Polyacrylonitrile was dissolved in dimethylformamide, so that the mixed solution was manufactured. About 6.7 parts by weight of zinc oxide (ZnO) based on 100 parts by weight of the mixed solution is dispersed in the mixed solution. Through the process, the viscosity of the mixed solution in which the ZnO was dispersed was adjusted to about 160 cP.

The nano-fiber was manufactured by electro-spinning the mixed solution. The electro-spinning must be performed under a condition of a voltage of 17 kV, the distance (TCD) of about 12 cm between the concentrator and the tip of an injector, a pump flow rate of 2.0 ml/h, and the rotation rate of the concentrator of about 200 rpm.

The nano-fiber manufactured through the electro-spinning was oxidized while raising a temperature at a rate of 2° C./min. In the final stage, the nano-fiber is oxidized at a temperature of 250° C. for three hours.

The nano-fiber, which had been oxidized, was carbonized while raising a temperature at a rate of 7° C./min. In the final stage, the nano-fiber was carbonized at a temperature of 1050° C. for one hour. In the process of carbonizing the nano-fiber, nitrogen (N₂) gas was injected at a flow rate of about 20 cc/min.

The nano-fiber, which had been carbonized, was dipped into 8M of a potassium hydroxide solution, shaken for on hour, and activated. The activation process for the nano-fiber was performed at a temperature of about 750° C. for three hours.

### Comparative Example 1

### Prepare of Nano-Fiber

Poly acrylonitrile was dissolved in dimethylformamide until the mixed solution of the Poly acrylonitrile and the dimethylformamide has the viscosity of 160 cP, so that the mixed solution was prepared. The subsequent processes of preparing the Nano-fiber are identical to those of Embodiment 1.

Analysis of Specific Surface Characteristic

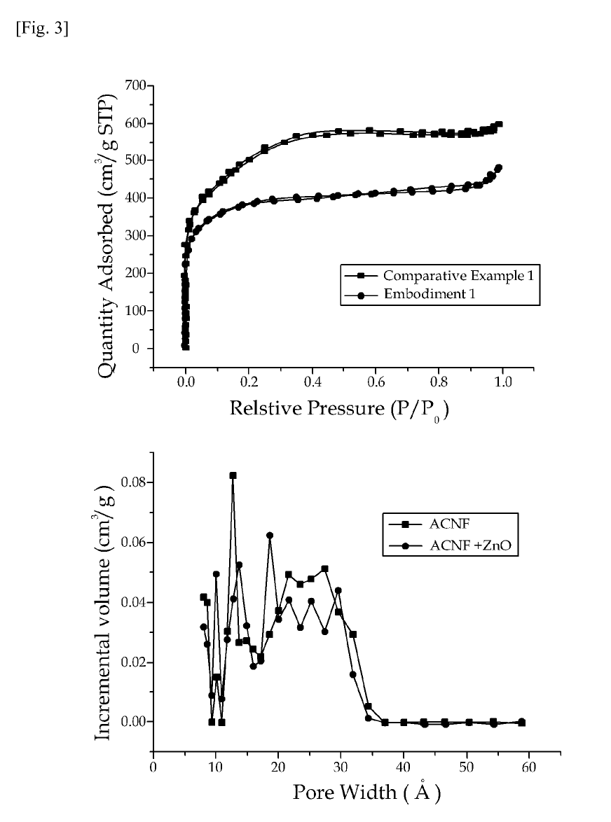

Specific surface characteristics of the nano-fibers according to embodiment 1 and comparative example 1 were analyzed and the result thereof was shown in FIG. 3. The nano-fiber according to embodiment 1 has the specific surface of about 1.305 m²/g, and the surface area of the nano-fiber having fine pores is 62% based on the specific surface. The nano-fiber according to comparative example 1 has the specific surface of about 1.741 m²/g, and the surface area of the nano-fiber having fine pores is 64% based on the specific surface. When comparing with comparative example 1, the nano-fiber according to embodiment 1 is reduced by about 25% in the specific surface, and reduced by about 3% in the surface area made by fine pores.

### Embodiment 2

### Manufacture of Gas Sensor Using Porous Nano-Fiber Including ZnO

The nano-fiber manufactured according to embodiment 1 was crushed into fine powder by using a mortar, and the powder of the nano-fiber was dispersed into dimethylformamide. In this dispersion process, 2 parts by weight of the powder of the nano-fiber was dispersed based on 100 parts by weight of dimethylformamide.

The mixed solution prepared through the above processes was dropped onto the silicon wafer, and then spin-coating was performed at a rotational rate of about 900 rpm for 4 minutes, thereby manufacturing the gas sensor.

In the final sage, the gas sensor deposited with the nano-fiber, which had been manufactured through the above process, was provided on a hot plate and heat-treated at a temperature of 40 for 0.5 hours.

### Comparative Example 2

### Manufacture of Gas Sensor Using Nano-Fiber

The nano-fiber manufactured according to comparative example 1 was crushed into fine powder by using a mortar, and the powder of the nano-fiber was dispersed into dimethylformamide. In this dispersion process, 2 parts by weight of the powder of the nano-fiber was dispersed based on 100 parts by weight of dimethylformamide. The subsequent processes of manufacturing the gas sensor are identical to those of Embodiment 2.

Surface Characteristic

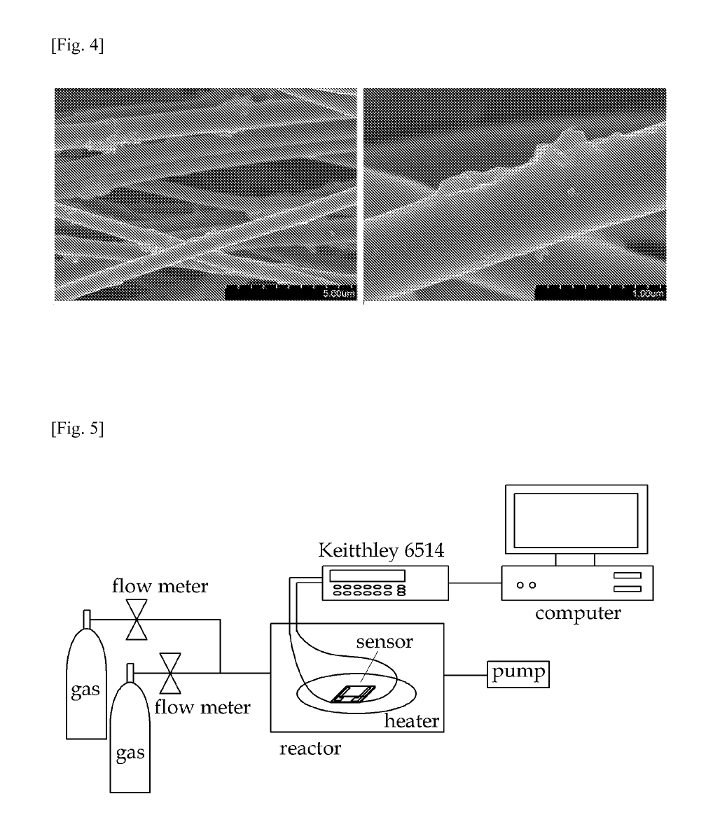

In order to observe the surface characteristic of the gas sensor manufactured according to embodiment 2, a picture of the gas sensor was taken by using an SEM (Scanning Electron Microscope) and shown in FIG. 4. As shown in FIG. 4, the porous nano-fiber including ZnO was uniformly deposited on the silicon wafer.

Gas Sensing Characteristic

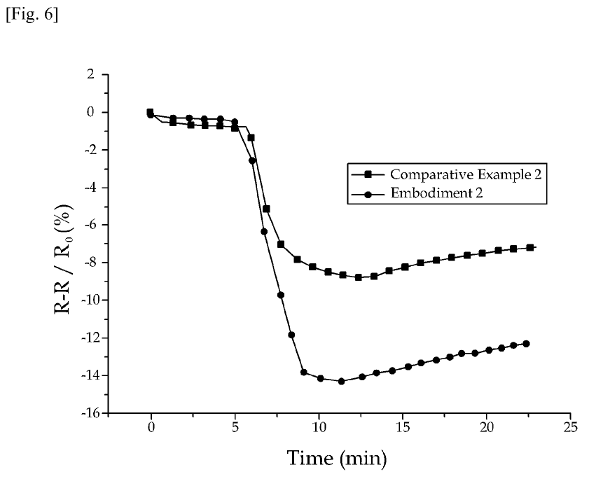

Hereinafter, the measurement and the estimation of the gas sensing characteristics of the gas sensors manufactured embodiment 2 and comparative example 2 will be described. FIG. 5 is a schematic view showing an apparatus to estimate the gas sensing characteristics. Before estimating the gas sensing characteristics, pre-processes for the gas sensors were performed at a temperature of 80° C. for 0.5 hours to evaporate the moisture of the gas sensors before the gas sensing characteristics were estimated. The gas sensing characteristics were measured by injecting NO gas with the density of 50 ppm at a temperature of 25° C. (normal temperature) by using the apparatus shown in FIG. 5, and the measurement result is shown in FIG. 6. As shown in FIG. 6, the resistance change ratio of the gas sensor according to embodiment 2 is about 13.5% in which the resistance change ratio represents the sensitivity of the gas sensor according to the sensing characteristic for the NO gas, and the resistance change ratio of the gas sensor according to comparative example 2 is about −9%.

In the graph shown in FIG. 6, an X axis represents a measurement time, and a Y axis represents the resistance change ratio. As shown in FIG. 6, the resistance change ratio of the gas sensor according to embodiment 2 at the N2 gas atmosphere is stabilized after about 4.5 minutes to about 5 minutes had been elapsed. In addition, time of about 4.5 minutes to about 5 minutes was required until the resistance change ratio reached a limited value at the atmosphere of about 50 ppm of NO. In contrast, the resistance change ratio of the gas sensor according to comparative example 2 at the N2 gas atmosphere is stabilized after about 5 minutes to about 6 minutes had been elapsed. In addition, time of about 6 minutes to about 7 minutes was required until the resistance change ratio reached a limited value at the atmosphere of about 50 ppm of NO.

Although the gas sensor according to the embodiment of the present invention has the specific surface smaller than that of the gas sensor according to the comparative example, the gas sensor according to the embodiment of the present invention can represent the higher resistance change ratio and the shorter response time at a normal temperature. This is because the metal oxide constituting the gas sensor according to the embodiment of the present invention serves as a catalyst, so that the activation of the nano-fiber can be increased.

Therefore, the gas sensor according to the embodiment of the present invention can represent the higher resistance change ratio and the shorter response time at a normal temperature. In other words, the gas sensor according to the embodiment of the present invention has higher sensitivity at a normal temperature.

Although the exemplary embodiments of the present invention have been described, it is understood that the present invention should not be limited to these exemplary embodiments but various changes and modifications can be made by one ordinarily skilled in the art within the spirit and scope of the present invention as hereinafter claimed.

1. A method of manufacturing a gas sensor comprising:
(1) mixing a polymer precursor with a solvent;
(2) dispersing metal oxide into the mixture obtained through step (1);
(3) preparing a nano-fiber by performing electro-spinning with respect to the mixture obtained through step (2);
(4) oxidizing the nano-fiber obtained through step (3);
(5) carbonizing the nano-fiber that has been oxidized through step (4);
(6) activating the nano-fiber that has been carbonized through step (5); and
(7) manufacturing the gas sensor by depositing the nano-fiber, which has been activated through step (6), between electrodes of a silicon wafer.

2. The method of claim 1, further comprising performing heat treatment with respect to the gas sensor, which has been obtained through step (7), after step (7) has been performed.

3. The method of claim 1, wherein the mixture, which has been obtained through step (2), has viscosity in the range of 100 cP to 500 cP.

4. The method of claim 1, wherein, in step (2), 2 to 10 parts by weight of the metal oxide is dispersed into the mixture, which has been obtained through step (1), based on 100 parts by weight of the mixture.

5. The method of claim 1, wherein, in step (4), the nano-fiber is oxidized while raising a temperature at a rate of 1° C./min to 5° C./min, and oxidized at a temperature of 200° C. to 300° C. for two hours to five hours in a final stage.

6. The method of claim 1, wherein, in step (5), the nano-fiber is carbonized while raising a temperature at a rate of 5° C./min to 10° C./min, and carbonized at the temperature of 800° C. to 1200° C. for a half an hour to two hours in a final stage.

7. The method of claim 1, wherein the activation in step (6) of the nano-fiber is achieved by applying a potassium hydroxide solution.

8. The method of claim 7, wherein the potassium hydroxide solution has density in a range of 5 M to 10 M.

9. The method of claim 1, wherein, in step (7), the gas sensor is manufactured by dispersing the nano-fiber, which has been obtained through step (6), into a dispersion solution and depositing the nano-fiber between electrodes of a silicon wafer.

10. The method of claim 9, wherein the dispersion solution is selected from the group consisting of ethanol, methanol, acetone, dimethylformamide, and the mixture thereof.

11. The method of claim 9, wherein a ratio of the nano-fiber dispersed into the dispersion solution is in a range of 0.1 to 3 parts by weight based on 100 parts by weight of the dispersion solution.

12. The method of claim 2, wherein the heat treatment is performed at a temperature of 30° C. to 80° C. for 0.1 to one hour.

13. (canceled)
